(19) United States
(12) Patent Application Publication
(10) Pub. No.: US 2018/0112404 A1
(43) Pub. Date: Apr. 26, 2018

(54) Door Element or Wall Element

(71) Applicant: Deceuninck NV, Hooglede-Gits (BE)

(72) Inventors: Erik De Maeyer, Hooglede-Gits (BE); Peter Degrande, Hooglede-Gits (BE); Wim Hanssens, Hooglede-Gits (BE)

(21) Appl. No.: 15/562,867

(22) PCT Filed: Apr. 14, 2016
(86) PCT No.: PCT/EP2016/058272

§ 371 Date: Sep. 28, 2017

(30) Foreign Application Priority Data
Apr. 14, 2015 (EP) 15163593.5

(51) Int. Cl. E04C 2/38; E06B 3/964; E04C 2/26; E06B 3/72

(52) U.S. Cl. CPC E04C 2/388; E06B 3/9645; E04C 2002/3488; E06B 3/726; E04C 2/26

(57) ABSTRACT

A door or wall element includes a frame having four hollow profiles; two side panels at opposed sides of the frame and attached to the frame; at least two of the profiles, positioned at opposed sides of the frame, include a groove at the sides of the profiles defining the outer circumferential surface; and each of the side panels at opposed edges has an upstanding rim fitting into the slot of the frame. The element includes a connection piece between two adjacent profiles of the frame wherein the profiles are mitred and the connection piece includes a body having a cross section matching the inner space of a first profile and inserted therein. The body has a mitred end surface from which at least one toothed part protrudes in a direction perpendicular to the longitudinal direction of the body and fits in the inner space of an adjacent second profile.

### TECHNICAL FIELD

The present invention concerns a door or wall element comprising a frame sandwiched between two, preferably metallic panes and whereby the inner cavity created between, on the one hand the frame and, on the other hand, both panes is filled with an insulating material.

### BACKGROUND FOR THE INVENTION

A door of the above mentioned type is known to be made by providing the metallic panes at two opposed longitudinal sides with a J-shaped rim comprising a lip that is grips in a groove at the outer perimeter of the frame, thereby positioning the panels to the frame.

As schematically represented in FIG. 1, such door is usually manufactured by first shaping the panes by providing these with the J-shaped rim, placing one pane on a registered table, placing the profiles for assembling the frame on the first pane in the shape of a parallelogram and placing the second pane on top of the profiles. By subsequently pushing on one of the lateral frame profiles to force the frame in a rectangular shape, the longitudinal profiles are driven apart and the J-shaped rims of the panes are forced into the corresponding grooves of the longitudinal frame profiles to assemble the door. Subsequently a hole is made in one of the profiles and a liquid PU-foam is inserted in the internal cavity to fill that cavity with a insulating material.

Up to present the profiles of such door are manufactured in wood. In order toincrease life time of the door, lower production costs and increase moistureresistance, there is a market demand for replacing the wooden frame by a polymeric frame. Additionally there is a market demand for other designs of this type of door elements such as flush door elements.

However, due to the fact that polymeric profiles, in order to be light weight and structurally rigid, are hollow profiles, a one on one exchange of wooden profiles by polymeric profiles does not allow manufacturing the doors with the known process, in particular since the process will leave the inner space of the profiles visible in the finished door and/or the inner space in the profiles will remain open to the inner cavity of the door, such that filling the inner cavity of the door with liquid PU material will cause leakage of the PU to the outside through the inner space of the profiles.

The present invention provides a solution to the above identified problems and aims at providing a door or wall panel of the type comprising a frame sandwiched between two preferably metallic sheets.

### SUMMARY OF THE INVENTION

The present invention concerns a door or wall element comprising:
a frame comprising four elongated profiles;
two, preferably metallic, side panels provided at opposed sides of the frame and attached to said frame;
at least two of the profiles positioned at opposed sides of the frame, provided with a slot or groove situated at the sides of the concerned profiles defining the outer circumferential surface of the frame;
each of the side panels provided at opposed edges with a upstanding rim fitting into the concerned slot or groove of the frame;
   wherein said profiles are hollow and preferably manufactured in a polymeric material.

The frame preferably comprises a connection piece provided between two adjacent profiles of the frame, said connection piece mad as an L-shaped connection piece comprising two side walls:
a first side wall defining a first abutment surface positioned against a cross-sectional end surface of a first profile of said frame and extending from an inner circumference of the frame to an outer circumference of the frame;
a second side wall defining a second abutment surface extending from said first wall to the outer circumference of the frame and positioned against a cross-sectional end surface of a second frame profile;
   the connection piece having a guide surface defined by a surface of the first side wall opposed to the first abutment surface and extending from the inner circumference of the frame to the second abutment surface.

The first abutment surface of the connection piece preferably extends in a plane oriented perpendicular to the plane wherein the second abutment surface extends.

It is further preferred that the first abutment surface matches the cross-sectional end surface of the first frame profile and/or the second abutmentsurface matches the cross-sectional end surface of the second frame profile and/or that the surface of the second wall opposed to the second abutment surface is profiled in accordance the outer circumferential frame surface defined by the first frame profile.

According to a preferred embodiment of the invention, the guide surface of the connection piece extends along a plane defining an angle a with the plane wherein the first abutment surface extends and defining an angle R with the plane wherein the second abutment surface extends, whereby 0°<α<90° C. and 90°<β<180°.

According to another embodiment of the present invention the profiles are mitred and wherein the connection piece comprises a body having a cross section matching the inner space of a first profile and inserted therein, the body having a mitred end surface from which at least one toothed part protrudes in a direction perpendicular to the longitudinal direction of the body, the toothed part fitting in the inner space of an adjacent second profile. The toothed part preferably has a cross-sectional surface area that gradually diminishes from the mitred surface towards the free end of the toothed part.

### BRIEF DESCRIPTION OF THE FIGURES

FIG. 1 shows a prior art wooden frame positioned in a parallelogram set-up ready for assembly;

FIG. 2 shows a door element according to the present invention;

FIGS. 3a&b illustrate a connection of a profile with side panels of a doorelement (flush design) according to the present invention;

FIGS. 4a&b represents a perspective view of a connection piece and profile of a door according to the present invention;

FIG. 5 shows a frame of a door according to the present invention in a parallelogram set-up ready for assembly;

FIGS. 6a&b represents a detailed view of a preferred embodiment of a connection piece in FIG. 4;

FIGS. 7a&b represents a perspective view of an alternative connection piece and profile of a door according to the present invention.

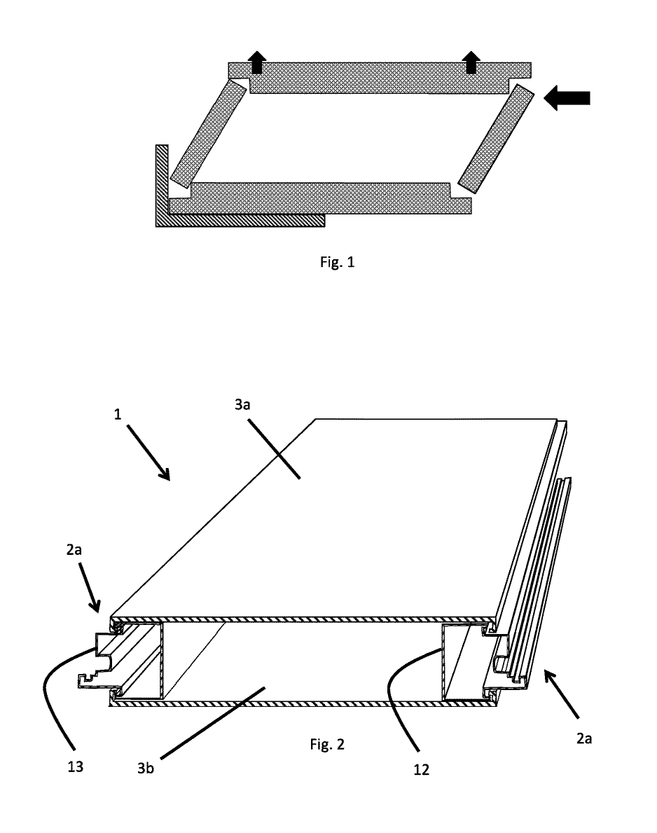

### DETAILED DESCRIPTION OF A PREFERRED EMBODIMENT

FIG. 2 schematically represents a door element 1 according to the present invention, the door element comprising:
a frame 2 comprising four 2a&b elongated profiles;
two side panels 3a&b provided at opposed sides of the frame 2 and attached to said frame.

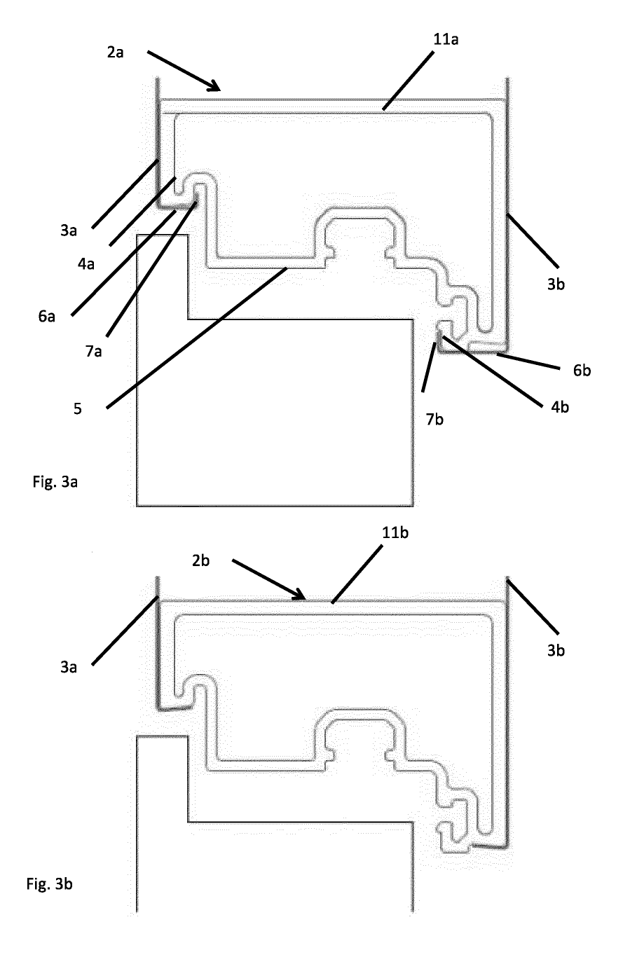

As illustrated in more detail in FIG. 3a, at least two of the profilespositioned at opposed sides of the frame, in this case the verticallypositioned profiles 2a are provided with a slot or groove 4a&b situated at the sides 5 of the concerned profiles defining the outer circumferential surface of the frame. The side panels 3a&b are provided at opposed edges with a upstanding rim 6a&b that at its free end comprises a bead 7a&b extending substantially perpendicular to the concerned side panel and fitting into the concerned groove 4a&b of the frame.

According to the invention, the frame members are hollow profiles that are preferably manufactured in a polymeric material such as PVC and most preferably in a reinforced polymeric material.

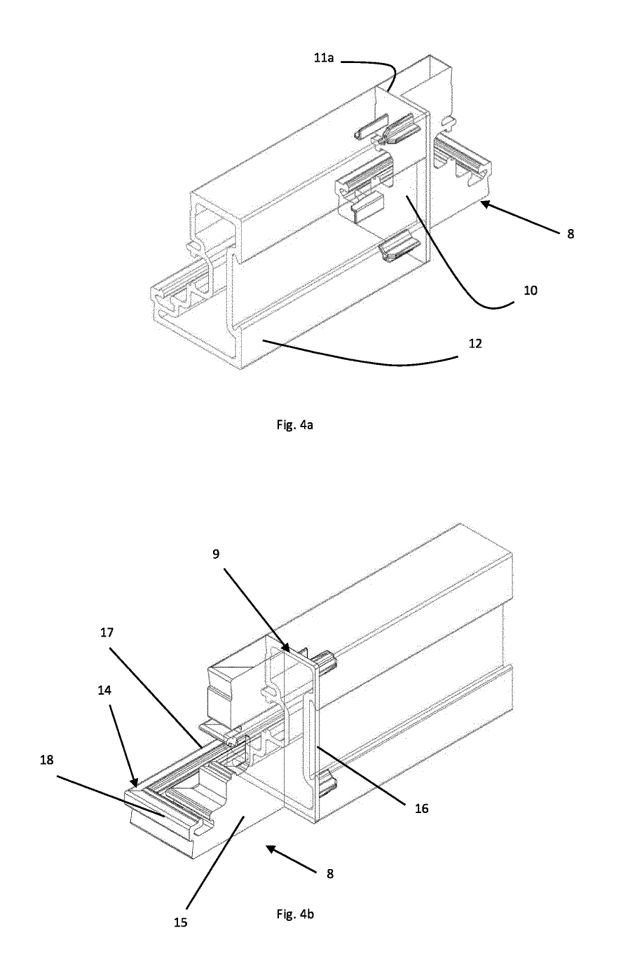

FIGS. 4a&b show a detail of a frame of a first embodiment of a door element according to the present invention, wherein the frame 2 comprises a connection piece 8 provided between two adjacent frame profiles 2a and 2b. This connection piece is preferably manufactured in a polymeric material and comprising two side walls:
a first side wall 9 defining a first abutment surface 10 positioned against a cross-sectional end surface 11a of a first (vertically positioned) profile 2a of said frame and extending from an inner circumference 12 of the frame to an outer circumference 13 of the frame;
a second side wall 14 defining a second abutment surface 15 extending from said first wall 9 to the outer circumference 13 of the frame and positioned against a cross-sectional end surface 11b of a second (horizontally positioned) frame profile 2b.

The connection piece further defines a guide surface 16 defined by a surface of the first side wall 9 opposed to the first abutment surface 10 and extending from the inner circumference 12 of the frame to the second abutment surface 15.

In this case the first abutment surface 10 extends in a plane oriented perpendicular to the plane wherein the second abutment surface 15 extends.

The first abutment surface 10 matches the cross-sectional end 11a surface of the first frame profile 2a, thereby closing off the inner cavity of the hollow profile 2a at the concerned end, while the second abutment surface 15 matches the cross-sectional end surface 11b of the second frame profile 2b to close off the inner cavity of the hollow profile 2b at the concerned end.

The guide surface is preferably positioned against the inner circumferential surface of the frame defined by the second frame profile 2b such that an inner space of the door element defined between, on the one hand, the frame profiles 2a&b and, on the other hand, both side panels 3a&b, is physically separated from the inner cavity defined by the hollow profile 2b, even in case of an eventual tolerance on the profile length making that the cross-sectional end surface 11b of the profile 2b would not perfectly abut the second abutment surface 15 and as such preventing that a liquid foam, when inserted in the inner space of the door element for insulation purposes would leak into the inner cavity of the frame profile 2b.

The surface 17 of the second side wall 14 opposed to the second abutment surface 15 is preferably profiled in accordance the outer circumferential frame surface defined by the first frame profile 2a, whereas the surface 18 defined by the free of the second side wall 14 is preferably profiled in accordance with the outer circumferential frame surface defined by the first frame profile 2b. As such any fittings to be provided at the outer circumferential surface of the frame can be provided both at the profiles 2a&b and at the connection piece 8.

FIG. 5 schematically illustrates an assembly method of a door element according to the present invention, whereby the profiles 2a and 2b are positioned in a parallelogram on an assembly table. In this case the frame profiles 2a intended to constitute the vertically oriented posts of the door element are provided at their both ends with a connection piece, while the frame profiles 2b intended to constitute the vertical posts of the door element are positioned such that their end portions are positioned on the guide surfaces 16 of the corresponding connection pieces 8. One of the frame profiles 2a is positioned along and against a first longitudinally extending L-shaped register wall while one of the connection pieces of that profile abuts, with its free end surface 18 of the second side wall 14, against the transversally extending part of the register wall such as to block that profile 2a from moving.

One side panel 3a is provided under the frame profiles, with one of its beads 7a,b arranged in the corresponding groove 4a, b of the immobilised profile 2a and the other side panel 3b is provided on top of the frame profiles with one of its beads 7a,b arranged in the corresponding groove 4a, b of the immobilised profile 2a.

Subsequently, the profile 2a positioned opposite the immobilized frame profile is pushed towards the transversally extending register wall part, thereby forcing the parallelogram in a rectangular shape and hence increasing the distance between the immobilized profile and its opposite counter profile of the frame and forcing the beads 7a, 7b of the side panels in the concerned grooves 4a, 4b of the opposite counter profile 2a.

As during the above described assembly of the door element, the transversal frame profile facing the transversally extending register wall part pivots versus the longitudinally extending profiles, the outwardly facing corner 19 of that profile 2b will push the immobilized longitudinal profile away from the transversally extending register wall part and hence disrupt a correct assembly of the door element. In order to prevent moving of the immobilized profile during assembly it is therefore preferred that the transversally extending register wall part comprises a cut-out portion allowing pivoting of the outwardly facing corner 19 without abutting the register wall part.

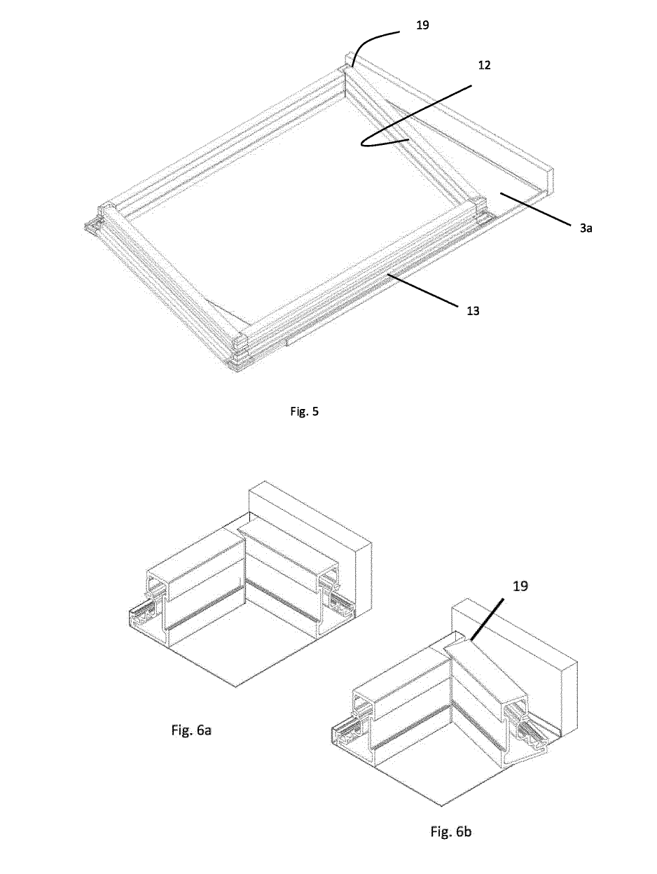

Alternatively, the corner piece can be provided with a sloped guide surface 16 as shown in FIGS. 6a&b, preventing the outwardly facing corner from abutting the register wall during the assembly of the frame.

In this case, the guide surface 16 extends along a plane defining an angle a with the plane wherein the first abutment surface extends and defining an angle R with the plane wherein the second abutment surface extends, whereby 0°<α<90° C. and 90°<β<180°.

After the above described assembly steps, the opposed transversally extending edges of the side panels are bent over to abut the outer surfaces of the transversal profiles 2b (FIG. 3b), where after a liquid foam is injected and cured in the space defined in the door element to increase insulation properties.

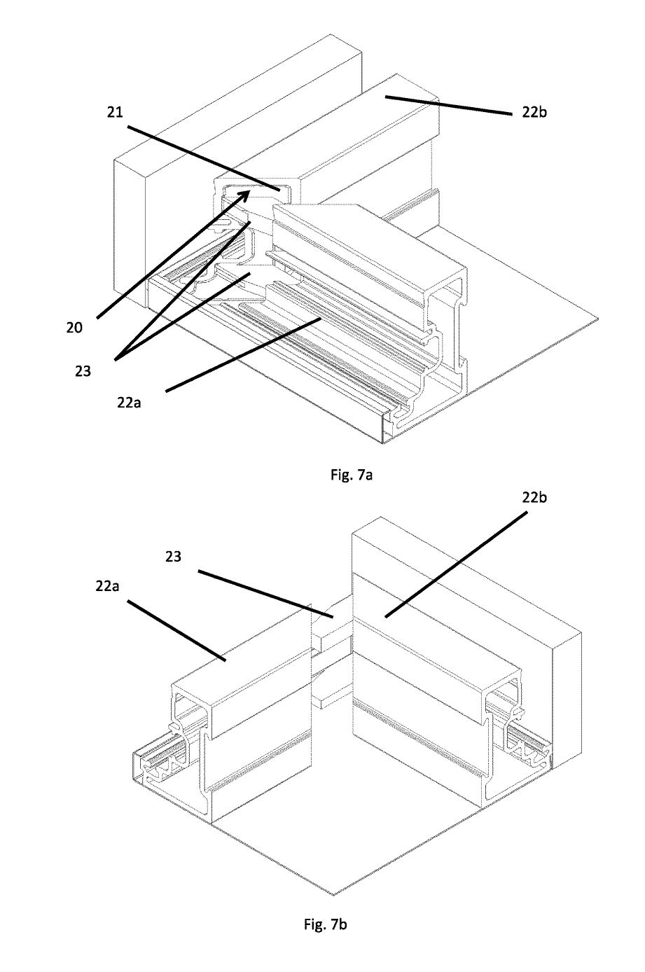

In FIGS. 7a&b, an alternative embodiment of the door element according tothe invention is shown, whereby the profiles 22a&b have mitred endportions. In this case the connection piece comprises a body 20 having a cross section matching the inner space of a second (transversally/horizontally) extending profile 22b and inserted therein, the body 20 having a mitred end surface 21 from which at least one toothed part 23 protrudes in a direction perpendicular to the longitudinal direction of the body 20, the toothed part fitting in the inner space of an adjacent first profile 22a.

The toothed part in this case has a cross-sectional surface area that gradually diminishes from the mitred surface towards the free end of the toothed part.

Assembly of the frame according to the alternative embodiment of FIGS. 7a&b can be achieved by providing a first side panel 3a, positioning the opposed longitudinal frame profiles 2a and 2b such that the beads 7a&b fit in the grooves 4a&b, subsequently positioning the second side panel 3b such that the beads 7a&b fit in the grooves 4a&b and then providing the transversal profiles 2b with the connection pieces are provided on the transversally extending profiles 2b and pressing the toothed parts of the connection pieces in the longitudinal profiles 2a, after which the transversal edges of the panels 3a and 3b can be bent over to abut the outer surfaces of the transversal profiles 2b (FIG. 3b), and a liquid foam is injected and cured in the space defined in the door element to increase insulation properties.

1. A door or wall element comprising:
a frame comprising four elongated hollow profiles;
two side panels provided at opposed sides of the frame and attached to said frame;
at least two of the profiles positioned at opposed sides of the frame, provided with a groove situated at the sides of the concerned profiles defining the outer circumferential surface of the frame;
each of the side panels provided at opposed edges with an upstanding rim fitting into the concerned slot or groove of the frame;
comprising a connection piece provided between two adjacent profiles of the frame
wherein the profiles are mitred and wherein the connection piece comprises a body having a cross section matching the inner space of a first profile and inserted therein, the body having a mitred end surface from which at least one toothed part protrudes in a direction perpendicular to the longitudinal direction of the body, the toothed part fitting in the inner space of an adjacent second profile.

2. The door or wall element according to claim 1, wherein said panels are manufactured in a metallic material.

3. The door or wall element according to claim 1, wherein the toothed part has a cross-sectional surface area that gradually diminishes from the mitred surface towards the free end of the toothed part.

4. The door or wall element claim 1, wherein the profiles are manufactured in a polymeric material.

5. The door or wall element claim 2, wherein the profiles are manufactured in a polymeric material.

6. The door or wall element claim 3, wherein the profiles are manufactured in a polymeric material.
